(19) United States
(12) Patent Application Publication
(10) Pub. No.: US 2003/0140223 A1
(43) Pub. Date: Jul. 24, 2003

(54) Automatic configuration of devices for secure network communication

(76) Inventor: Robert Desideri, New York, NY (US)

Correspondence Address: FITZPATRICK CELLA HARPER & SCINTO, 30 ROCKEFELLER PLAZA, NEW YORK, NY, 10112, US

(21) Appl. No.: 10/190,502

(22) Filed: Jul. 9, 2002

Related U.S. Application Data
(60) Provisional application No. 60/351,545, filed on Jan. 23, 2002.

(51) Int. Cl. H04L 9/00

(52) U.S. Cl. 713/153

(57) ABSTRACT

A system and method are provided for automatically establishing secure communications through one or more networks. Execution of node server operating software is initiated on a first node server. A secure communication connection is authenticated between a first node server and a master control server having an account database. An account status of the first node server is verified by accessing the account database. In the master control server, a unique identification key pair is associated with the first node server. The identification key pair has a public key and a private key. The public key of the key pair is stored in a master node server database on the master control server. The private key of the key pair is stored in the first node server. At least a portion of the master node server database is sent to a second node server, including the public key associated with the first node server. At least a portion of the master node server database is sent to the first node server, including a public key associated with the second node server.

This application claims the benefit of U.S. Provisional Application No. 60/351,545, filed Jan. 23, 2002.

### BACKGROUND OF THE INVENTION

1. Field of the Invention

The present invention relates generally to management of network data communications and specifically to a method and system for automatically and opportunistically configuring and operating secure network topologies and secure communications in dynamic data communications topologies.

2. Related Art

Conventionally, setting up and managing secure communication between nodes in a data communications network requires the manual configuration of each individual node. However, the logistics of manually configuring each node can become quite burdensome when the number of nodes is large, different entities control each node and the possibility of software heterogeneity exists. The burden increases when more than one network is utilized and devices need to be configured to communicate over such networks either preferentially or in parallel.

The logistics of setting up and managing secure communications can be somewhat simplified by downloading a configuration information table to each node. However in a system with a dynamic topology, the configuration information table would need to be updated and downloaded frequently, which would be inefficient. Furthermore, in large networks such an information table would be quite large and would possibly contain a great deal of extraneous information, as nodes would not necessarily need to communicate with every other node.

The need for secure data communication networks arises from the fact that communicating over public networks such as the Internet is inherently insecure. Just as a telephone can be tapped and a conversation can be eavesdropped upon, an email message has similar vulnerability. As an email traverses the public network it can be eavesdropped upon or “sniffed”, as it is known in the art of network communications. Reasons for sniffing include industrial espionage, hacker attacks and governmental surveillance.

In addition to being sniffed, unsecure email communication can be intercepted, altered by a third party, and then sent along to the unsuspecting intended recipient. This type of security compromise is known as a “man in the middle attack”. With neither the sender nor the recipient aware of the modification to the email, both parties are at risk. For example, a sender of an email may instruct the recipient to effect a funds transfer to a specified bank account in a specified amount. It would be disconcerting to at least one of the parties if that message were to be altered en route unbeknownst to the parties. Equally, a malicious party could create an email masquerading as another sender, a practice known as “spoofing” to those practiced in the art of network communications. The present invention eliminates such problems by automatically securing emails while they traverse public networks, such as the Internet.

Conventional email servers, such as Simple Mail Transfer Protocol (SMTP) servers, normally communicate “in the clear”, i.e., without security measures, such as encryption. In many cases such email communication traverses one or more routers that are neither controlled nor trusted by the sending and receiving parties. While SMTP is a protocol that is defined by the Internet Engineering Task Force (IETF) and that enables systems such as Lotus Notes™, Microsoft Exchange™ and Novell GroupWise™ to inter-communicate, it does not provide a trusted and native means for such systems to communicate securely. Furthermore, such SMTP-based systems provide no means to authenticate the source or integrity of emails. The present invention overcomes these deficiencies.

Although both public domain and proprietary cryptographic algorithms are available to provide secure communication, the methods and systems used to implement such algorithms are cumbersome, complicated to maintain, and susceptible to operator error. One particular deficiency of conventional methods for implementing cryptographic algorithms is that they generally require each user to manually install and configure software on the each individual user's computer, which increases the potential for security compromise.

For example, PGP is a widely used cryptography system that requires cryptographic software to be installed and configured on each user's computer. In a PGP-based system, email is transmitted and received in encrypted form and must be encrypted and decrypted by individual users. Because the PGP is implemented by individual organizations and/or individual users, there is no guarantee of adherence to accepted security practices, i.e., “best practices”, by the parties using the software, so each party can only hope that the counter-party is adhering to best practices. Thus, if a user has disabled or forgotten to use the software or, perhaps worse, intentionally avoids using the software, then security is breached and information is unauthenticated and travels in the clear. In addition, if a user has been fired or the user's private key is lost, the user's email is unrecoverable without deployment of complicated and somewhat risky key escrow systems. The present invention eliminates these deficiencies, as it does not require such manual operations by the user. Further, the present invention does not require installation of cryptographic software on each individual user's computer. The present invention enables both non-secure communication with non-participating nodes and secure communication via one or more communications networks with participating nodes without manual operation.

Another problem with PGP is that it requires key sets to be issued for each individual user. Thus, key management and coordination becomes a significant problem between two or more organizations that have large numbers of users. Furthermore, PGP is applied at the application level, which means that it typically is used to secure email, but not HTTP traffic, FTP data transfers or other types of communication. Similarly, many other cryptography solutions implemented on desktop computers in an organization must operate at the application level, because of the heterogeneous platforms and configurations used in the organization.

Another conventional method for providing secure communication is a Virtual Private Network (VPN). A VPN employs cryptographic techniques to authenticate the parties connecting to the VPN and to encode and decode email messages. For example, a VPN may employ Secure Tunnel Adapters that enable the nodes of the network to communicate with one another using well-known authentication and encryption algorithms, such as Diffie-Helman Key Exchange and Rijndael. However, configuring local area networks (LANs) or individual devices to communicate securely via VPNs with other LANs or individual devices is typically a cumbersome manual process.

For example, setting up a VPN between two LANs typically requires the manual configuration of a router at the bridge point of each LAN. However, configuring the router of one LAN requires specific knowledge regarding the router of the other LAN, such as the public Internet Protocol (IP) address of the other router and a secret logon password, sometimes known as shared secret or a Public Key Infrastructure (PKI) authentication method. To configure each router, a system administrator must manually log on to each router, locally or remotely, and input the specific information. In addition, it is often the case that other parameters, such as communications settings, must also be manually specified and configured. The level of coordination required to gather such information and configure and test the VPN can be burdensome and particularly so in heterogeneous networks. VPN establishment is further complicated when the routers are maintained by different administrators, as is often the case. Similar problems arise in setting up communication via a VPN with an individual device.

It is a security good practice to not use the same administrative logon passwords for each router, e.g., user name and password. The reason for this is that the damage from compromised passwords can be contained more easily. Further, it is also good practice to use different router-to-router VPN authentication passwords for each combination of router pairs to contain damage should passwords be compromised. Clearly, the manual administrative task is never ending for each administrator as nodes are added and removed from the network as well as when passwords are updated, because the configuration required is one-to-one and the combinatorial effect is daunting.

The present invention eliminates the need to manually pre-configure, and on an ongoing basis re-configure, each router to connect each VPN pair. Rather, with the present invention, each node intelligently configures itself on an opportunistic basis such that a VPN between itself and another node is built, used and torn down. Thus, the opportunity for misconfiguration of nodes resulting from operator error is eliminated. In addition, the overhead costs resulting from the conventional manual configuration and maintenance steps for adding new nodes and removing undesired nodes from the network are significantly reduced.

A VPN may be used in connection with a conventional key management system, such as PKI, which is a system for managing public keys used to enable the build-up of VPN connections between LANs. PKI systems are essentially database schemes for managing mathematically linked key pairs and certificates issued by one or more Certificate Authorities (CA). A certificate is a cryptographic representation comprising the public or private key, of a related key pair, which also includes further information, such as the name of the CA that issued the key pair as well as the permitted use and authorized start and end dates. This information is signed by a CA's private key to allow verification that none of the information has been tampered. Those skilled in the art of cryptography are familiar with the well-known and public x.509 standards for such certificates as well as alternative proprietary embodiments.

One deficiency of PKI systems is that they require the installation and manual configuration of PKI software on servers and client machines. An alternative to installing PKI software is outsourcing the PKI server operation, however burdensome coordination is required to install and operate such systems. 100161 Another deficiency of PKI systems is the enrollment process, which requires manual verification and approval of the applicant before certificates are issued by the CA. The issuance of the certificates following the manual approval process is itself a tedious process subject to human error. The steps typically include manual initiation of programmatic key-pair generation. The recipients of the certificates typically must manually download and manually install the certificates. Further, each node must accept the public key of the CA to be able to verify that the certificates of counter-parties contain authentic CA signatures. The automatic enrollment feature of the present invention, as described herein, eliminates such deficiencies.

Compounding the problems associated with PKI systems is the fact that there are numerous providers of both PKI software and certificates, which present inter-operational compatibility issues. Consequently, while one domain administrator may succeed in implementing a PKI system for local users, the system may be incompatible with that used in the domain or network with which communication is to occur, resulting in the failure to establish secure communication. Though there have been numerous attempts to create compatibility standards for PKI systems and certificates, many businesses are disenchanted with the onerous configuration requirements and compatibility issues. The present invention eliminates the deficiencies of present PKI and certificate schemes by automatically and transparently issuing and revoking certificates for each node and not requiring users to manually configure PKI software or servers. In addition, there is no guarantee of consistent best practices across the various CA companies. The same is true across the various PKI client software products. The present invention addresses such deficiencies with its algorithmic processing feature to apply rules and decisions processes in handling certificates and keys.

In addition to the problems associated with conventional methods and systems for implementing secure data communication discussed above, there are problems associated with conventional methods and systems for providing secure node addressing. For example, conventional node addressing methods rely upon insecure name resolution and directory systems, such as the public Domain Name System (DNS) and DNS Registry. One deficiency of the DNS system is the lack of strong authentication requirements for altering DNS data such as addresses. Moreover, multiple vendors have access to the DNS Registry. Each vendor has varying methods and requirements for updating the DNS Registry, thus making the system susceptible to error and mischief. The present invention eliminates such deficiencies by managing node initialization and modifications securely and within internal data stores.

Another deficiency of the DNS is the lack of centralized control over DNS servers at all levels within the DNS system. For example, mid-level servers are typically located at and operated by Internet Service Providers while primary and secondary DNS servers are located at and operated both by corporate administrators and Internet Service Providers. The quality of administrative expertise, security and software varies location by location. The lack of central control allows such inconsistencies to become vulnerabilities. For example, such vulnerabilities have permitted “DNS tampering”, an attack that causes innocent users to be misdirected to malicious websites masquerading as authentic sites. The present invention eliminates such deficiencies by securely unifying control and communication of credentials.

Another deficiency of the DNS system is the heterogeneity of software. Though the various vendors of DNS software produce their products to meet the same specification in theory, it is well known that inconsistencies have caused operating problems. Further, the DNS system was originally designed for the narrow purpose of address translation. The DNS system operates within that scope and there is no provision in the specification for cross communication with other registries and systems. The closed nature of this system makes it difficult to perform computing operations requiring information from other data stores. For example, the DNS system does not contain a mechanism for comparing data from an alternative data source with its own data and a manipulation of such data. The present invention overcomes such deficiencies with algorithmic processors that enable manipulation of data collected from both internal and external data stores.

Yet another deficiency of the present DNS system is the inability to map addresses from different registries for alternate networks and configure nodes based on algorithmic processing of such maps. For example, when an email server does a DNS lookup to resolve a domain name to an IP address for a recipient's email there is no provision to provide processing instruction and addressing data to establish data communication to deliver the email via a network other than the Internet. The present invention eliminates this deficiency by enabling automatic connectivity via multiple networks. Such robustness is desirable in situations where communications speed must be optimized, where high reliability communication is mandatory and in an emergency during disaster recovery.

In view of the shortcomings discussed above, there is a need for a system that automatically configures secure network communications and overcomes the drawbacks of the conventional techniques.

### SUMMARY OF THE INVENTION

The present invention generally provides a novel method, system, and computer code for pre-qualifying and enrolling nodes to participate in a system for automatically establishing secure communication between the nodes.

One aspect of the invention provides a method, system, and computer code for pre-qualifying a node to participate in a system for automatically establishing secure communications through one or more networks. Pre-qualification data is received from a node via a network and is compared to a benchmark. An entry is created for the node in an account database if the pre-qualification data meet the benchmark. A unique identifier is generated for the node, and the unique identifier is stored in a master node server database. The unique identifier is associated with a copy of node server operating software, and a copy of the node server operating software is delivered to the node.

Embodiments of this aspect may include one or more of the following features. The unique identifier may be derived from the pre-qualification data, may include a signed certificate containing an unique identification key, or may include an Internet Protocol address of the node.

Another aspect of the invention provides a method, system, and computer code for automatically enrolling in a system for establishing secure communications through one or more networks. Execution of node server operating software is initiated on a first node server. A secure communication connection via a network is authenticated between a first node server and a master control server having an account database. An account status of the first node server is verified by accessing the account database. In the master control server, a unique identification key pair is associated with the first node server, the identification key pair having a public key and a private key. The public key of the key pair is stored in a master node server database on the master control server, and the private key of the key pair is stored in the first node server.

Embodiments of this aspect may include one or more of the following features. The private key may be purged from the master control server. At least a portion of the master node server database may be communicated to a second node server, including the public key associated with the first node server. At least a portion of the master node server database may be communicated to the first node server, including a public key associated with the second node server. Secure communication between the first node server and the second node server may be authenticated using the public keys associated with the first and second node servers.

Another aspect of the invention provides a first node server configured to initiate execution of node server operating software, a master control server having an account database, and a secure tunnel adapter configured to authenticate a secure communication connection between the first node server and the master control server via a network. An automatic enrollment module is provided in the master control server to verify an account status of the first node server by accessing the account database. A key-issuing module is provided in the master control server having a unique identification key pair associated with the first node server. A master node server database is provided in the master control server for storing a public key of the key pair. A private key database in the first node server for storing a private key of the key pair.

Another aspect of the invention provides a method, system, and computer code for automatically establishing secure communications through one or more networks. Data is received at a first node server via a network. If the data includes credentials of a second node server, it is determined whether a local node server database of the first node server has an entry for the second node server. If there is an entry for the second node server in the local node server database of the first node server, the credentials of the second node server are checked using the local node server database of the first node server. If there is not an entry for the second node server in the local node server database of the first node server or the credentials of the second node server do not pass the checking step, an update of the local node server database is requested from a master node server database on a master control server and repeating the checking step. It is determined whether to route the data through a secure tunnel adapter based on a result of the checking step.

Embodiments of this aspect may include one or more of the following features. If the master control server is inaccessible, the first node server may be allowed to authenticate the second node server using credentials of the second node server that have not passed the checking step, or using a digitally signed certificate previously received from the master control server. Address information associated with the data may be modified to route the data through a selected one of the one or more networks.

These and other objects, features and advantages will be apparent from the following description of the preferred embodiments of the present invention.

### BRIEF DESCRIPTION OF THE DRAWINGS

The present invention will be more readily understood from a detailed description of the preferred embodiments taken in conjunction with the following figures.

FIG. 1 is a block diagram that illustrates in general terms an embodiment of the present invention.

FIG. 2 is block diagram of an Intelligent Node Server.

FIG. 3 is a block diagram of the Master Control Server.

FIG. 4 is a block diagram of a Replica Control Server.

FIG. 5 is a flow diagram of the pre-qualification process.

FIG. 6 is a flow diagram of the automatic enrollment process.

FIGS. 7a and 7b are flow diagrams of the configuration and initiation of communication between Intelligent Node Servers.

FIG. 8 is a flow diagram of the unenrollment process.

FIG. 9 is a block diagram of the signaling system.

### DETAILED DESCRIPTION OF THE PREFERRED EMBODIMENTS

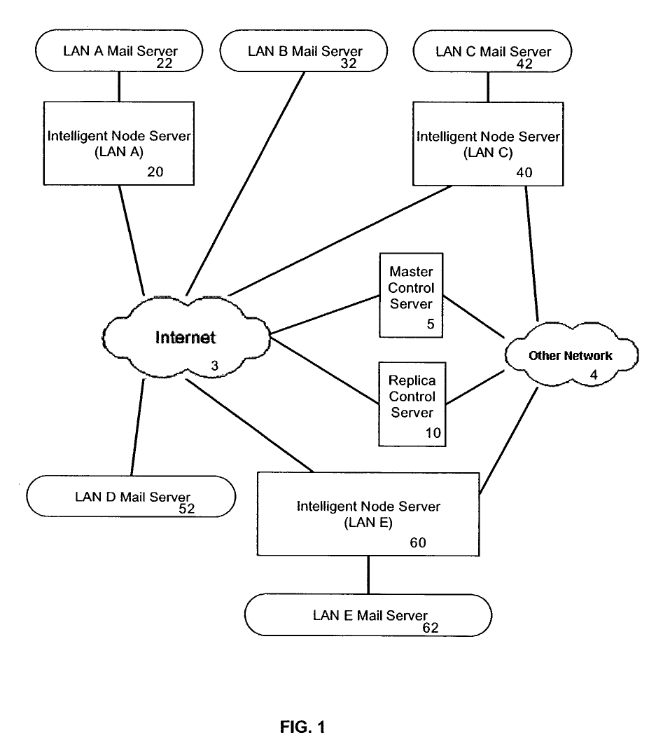

FIG. 1 depicts a block diagram that illustrates in general terms an embodiment of the present invention. In FIG. 1, a number of heterogeneous data networks, e.g., local area networks (LANs) or corporate domains (LANs A, B, C, D, and E), are connected through one or more networks, such as the Internet 3 and other networks 4. Each LAN participating in the secure communication system is provided with an Intelligent Node Server (INS) 20, 40, and 60 that acts as an edge point for connection with the Internet. The INS may be implemented on a computer that is connected between the LAN and the LAN's Internet router or within the LAN's Internet router. Alternatively, the INS may be implemented on a server that is already part of the LAN, such as an email server, as a new router, or within an existing router.

As further described below, each participating LAN is pre-qualified automatically by a central authority that controls the operation of the system. To pre-qualify, the central authority collects LAN related pre-qualification data, such as domain administrator contact information, a routable Internet Protocol (IP) address to be assigned to the INS for each network connection, the IP address for the email server of the LAN, and billing information. The central authority reviews the pre-qualification data and then accepts or rejects the LAN for participation in the system.

Once a LAN is accepted, an INS on that LAN is configured to automatically enroll itself into the system by signaling a Master Control Server (MCS) 5, which controls the operation of the system and maintains a database of LANs that are approved to participate in the system. The MCS 5 returns a base set of parameters and rules to the INS to enable it to execute a signaling system that automatically configures the INS to initiate communication with and respond to communication requests from other INS units over each connected network, such as the Internet 3, a private network or other network cloud 4, for which that INS is configured. The signaling system also enables an INS computer to permit communication with LANs that do not have an INS, i.e., that do not participate in the system though connected to a network. The MCS 5 also can automatically unenroll, i.e., disable, an INS so that it can neither initiate secure communications with nor respond to secure communications requests from other INS units.

The system may include one or more replica control servers (RCS) 10, which maintain a full or partial replica of the MCS 5. A portion of the signaling performed by the MCS 5 may be shifted to the RCS 10 to provide load balancing. In addition, the RCS 10 provides redundancy, which enhances system reliability.

An INS automatically enrolls in the system and creates a new up-time session periodically, for example, every time it is turned on or boots. The enrollment process initiates a public/private key process for authentication of each INS, the MCS, and each RCS. The process is fully automated within the system and is transparent to users and network administrators, thus eliminating the need for manual key management. The automated enrollment process also eliminates the need for the user to be aware of or administer any PKI system or client encryption application.

At least each time an INS automatically enrolls successfully, the INS is issued authentication credentials and configuration information, including at least one new up-time session private key and a corresponding public key. The INS also may be issued processing algorithms, which are stored in the Local INS Data Store. The processing algorithms are configured to request, manipulate and store data and process decisions. The processing algorithms may also include encryption and authentication algorithms.

The up-time session public key for the enrolled INS is stored in a database on the MCS. The MCS then distributes the public key to other INSs in response to key request signals it receives. Such signals are automatically generated by an INS opportunistically needing to send data to or receive data from another INS. Each INS is also configurable to respond to another INSs request for a public key.

This configuration enables an INS to communicate with another INS without signaling the MCS, which allows the system to provide a fail-over mechanism to ensure the ability to transfer data despite a temporary inability to access the MCS to check for revocations or other configuration changes. Thus, there is no need for a user or administrator to distribute or install such keys nor is there the need for an administrator to manually load revocation lists. The present invention is robust in that it is configurable to fail-over to alternative states without administrator intervention.

As further discussed below, the MCS, RCS, and INS units each contain a secure tunnel adapter (STA) that provides authentication and encryption for communication between these units using such public/private key pairs and encryption algorithms. Further, all such keys can be signed by the MCS or RCS and embedded within certificates, such as x.509 format certificates, which are essentially signed containers for data such as keys and may also comprise additional data. The MCS and the RCS act as Certificate Authorities (CA) that digitally sign each certificate. Thus, the MCS and any RCS and INS can easily verify the authenticity of each key and other parameters embedded with the key in such certificates.

In the preferred embodiment, each participating LAN has an email mail server configured to send email to the respective INS. For example, the Network A Mail Server 22 may be a corporate domain email server that is configured to direct all of its outbound Simple Mail Transfer Protocol (SMTP) email destined for other domains to the Network A INS 20. In another embodiment an INS, rather than being installed as a customer premises device, is installed at its network service provider and connected to the LAN of the customer via a private connection.

Each INS 20 is automatically configured to communicate outgoing email to the appropriate recipient's email server. For example, if the email is destined for a non-participating LAN, such as the LAN B 32 or LAN D Mail Servers 52, the INS 20 acts as a transfer agent to deliver the email via the Internet 3 using SMTP. However, if an email is destined for a participating network, such as the LAN C 42 or LAN E Mail Server 62, the INS 20 is automatically configured by the MCS 5 or RCS 10 to build a secure tunnel to the INS recipient LAN C or LAN E, respectively. This tunnel is used for transmission of encrypted data between the Secure Tunnel Adapters of the respective INSs.

The configuration information for an INS may include alternate IP addresses for use over alternate network clouds. These alternate IP addresses are mapped with primary IP addresses used over the primary network cloud. Such IP address mapping enables the present invention to both load balance and provide robustness. Secure tunnels can be established on networks other than the primary network without the need to change IP addresses on local machines or multiple home local machines. For example, if the Internet is the primary communications network for email and there is an interruption of Internet service (e.g., due to physical cabling disturbance, Internet routing table corruption or denial of service attack) an INS automatically configures itself to use an alternate network cloud if that alternate cloud is also available to the intended recipient. The email destined for a particular Internet address (e.g., president@whitehouse.gov) is automatically mapped to an address in the alternate cloud and delivered to the appropriate recipient INS via the alternate network cloud.

The MCS 5 may also be accessed via the alternate network cloud 4. The email servers on each LAN behind their respective INS are not affected by whether the Internet cloud 3 or an alternate cloud 4 is used for establishing communication between the INSs, as the INSs translate and map and un-map addresses automatically. This eliminates the need for manual intervention and configuration of servers to accommodate multiple communications connections. The INS configures its adapters and establishes communications with another INS based upon the results of algorithmic processing enabling connectivity for fastest response, emergency recovery during a fault on one communications network, load balancing and preferentially based upon rules received from the MCS or contained within the data transmission, such as a rule originally contained within and parsed from an email or rule based upon content of a data packet or data packet header.

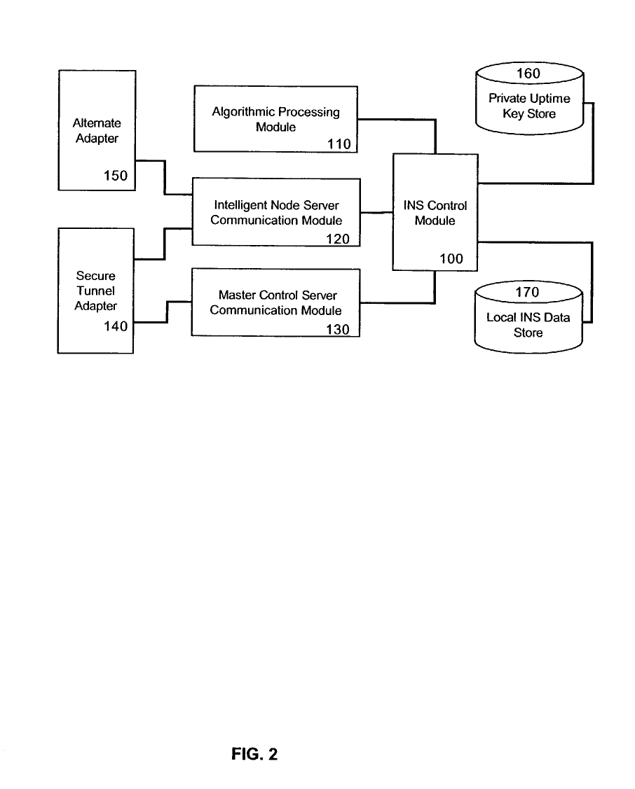

FIG. 2 is a block diagram showing the components of an INS. As discussed above, the INS uses a signaling system to intelligently configure itself to automatically communicate securely with the INSs of participating LANs or to communicate using conventional email protocols with non-participating LANs using parameters obtained from the MCS or an RCS via the signaling system and parameters obtained from the DNS. The INS is also configured to use the signaling system to automatically communicate securely with the MCS or an RCS for enrollment and key management. The INS Control Module 100 controls and manages these communication operations, as well as communication among the modules of the INS.

Communications between the INS and other INSs, the MCS, or an RCS are made using a Secure Tunnel Adapter (STA) 140, which can be implemented as either hardware or software, or a combination of the two. The STA 140 provides a secure tunnel, which is a data path for transmitting and receiving authenticated and encrypted data packets. The INS Communications Module 120 configures the STA 140 for communication with another INS. The Master Control Server Communications Module 130 configures the STA 140 for communication with the MCS or an RCS. For communication with non-participating LANs, the INS Communications Module 120 configures an alternative adapter 150, which communicates using conventional non-secured protocols, such as SMTP.

For example, to initiate communication with another INS, the INS Communication Module 120 configures its associated STA 140 to communicate with the STA of the recipient INS and transmits initializing data packets. Upon receiving such data packets from an authenticated INS, the recipient INS Communication Module 120 configures its associated STA 140 to communicate with the STA of the initiating INS. In configuring its STA, the recipient INS may use the signaling system to retrieve necessary information from the MCS to authenticate the initiating INS or verify the signature of a certificate received from the initiating INS along with other information, such as the IP address of the initiating INS. The initiating INS may also be configured to use the signaling system in a similar manner before configuring its STA. Once each STA is configured and initiated, a secure tunnel is formed and secure two-way data communication is enabled.

The Local INS Data Store 170 contains the information used to configure the STA 140, such as the IP address, domain name, public up-time key, and enrollment status of the recipient INS. In the preferred embodiment, each Local INS Data Store 170 obtains via the signaling system from the MCS or RCS the configuration information for another INS, opportunistically, on an as-needed basis. Alternatively, each Local INS Data Store 170 may have configuration information for all of the INSs in the system. The INS Control Module 100 invokes the Master Control Server Communications Module 130 to update the Local INS Data Store 170 to be in agreement with data stored on the MCS, as further discussed below.

The INS Control Module 100 applies enrollment data from the Local INS Data Store 170 to the Algorithmic Processing Module (APM) 110 to determine whether an intended recipient is a participating LAN, i.e., enrolled in the system. The Intelligent Node Server Communication Module 120 then configures and invokes the Secure Tunnel Adapter (STA) 140, the Alternate Adapter 150 (or no adapter) based on the output of the APM 110. The APM is also used to determine whether to update the Local INS Data Store from the MCS 905 or an RCS 910.

To configure the initiating STA 140 for data transmission, the INS Control Module 100 retrieves the public up-time key of the receiving INS from the Local INS Data Store 170, which corresponds to the private key of the receiving INS. To configure the receiving STA 140 for data reception, the INS Control Module 100 on the receiving INS retrieves the public uptime key of the initiating INS from the Local INS Data Store 170, which corresponds to the private key of the initiating INS. The private key of each INS is held in its respective Private Up-time Key Store 160. Thus, each INS uses the public key of the counter-party INS and its own private key to configure its STA using an authentication and key exchange technique such as the Diffie-Hellman Key Exchange method.

Each INS automatically updates the Private Up-time Key Store 160 and Local INS Data Store 170 without operator intervention. Such updates may occur each time the INS enrolls in the system, may occur more frequently or be triggered automatically upon a conditional event. To perform the update, the INS Control Module 100 invokes the Master Control Server Communications Module 130, which initiates secure communications via the signaling system with the Master Control Server through the STA 140. An INS is configurable to operate on a LAN as well as embedded in a wired or wireless stand-alone device. Such a device may or may not have other functionality in addition to an INS.

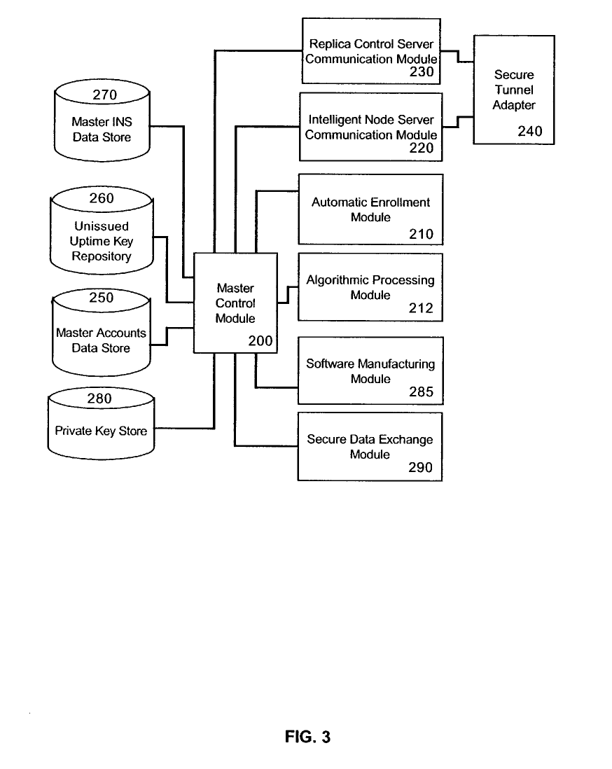

FIG. 3 is a block diagram showing the components of the Master Control Server (MCS) which controls the operation of the system. The MCS may be implemented on a computer that is connected to participating LANs via a network, such as the Internet. Alternatively, the MCS may be implemented on a server that is part of a participating LAN. The MCS is controlled by a Master Control Module 200, which initiates and manages communication processes with INSs and RCSs and controls communications among the modules of the MCS.

The MCS maintains the Master INS Data Store 270, which is a database of configuration information for all of the participating LANs. As described above, this configuration information is obtained using the signaling system by the INSs to update their Local INS Data Store 170. The information is used by each INS to establish communication with other INSs via their respective Secure Tunnel Adapters 140 (FIG. 2). The MCS has an Intelligent Node Server Communication Module 220 that configures the Secure Tunnel Adapter 240 to communicate with each INS in a manner similar to communication between two INSs. The MCS has its own private keys that are stored in the Private Key Store 280. The MCS uses these keys during the signaling system authentication process with the STAs of the MCS and the INSs. The STAs are configurable using techniques such as the Diffie-Hellman method, which is discussed in Applied Cryptography, Protocols, Algorithms, and Source Code in C, Second Edition, Bruce Schneider, John Wiley & Sons, Inc., which is incorporated herein by reference.

Each INS stores configuration and key information in the respective Local INS Data Store 170 and Private Up-time Key Repository 160 (FIG. 2). The Master INS Data Store 270 and the Local INS Data Store 170 may be implemented as a directory server and may use a method such as Lightweight Directory Access Protocol (LDAP), which enables key exchanges between a central database and a remote data store. LDAP is discussed in Big Book of Lightweight Directory Access Protocol (LDAP), Peter Loshin (Compiler), Bill McCarthy, Morgan Kaufmann Publishers, ISBN: 0124558437, which is incorporated herein by reference.

The Unissued Up-time Key Repository 260 stores up-time key pairs yet to be assigned to an INS. These up-time key pairs are unique and may be used as identifiers. The key pairs may be generated using techniques such as the Rivest-Shamir-Adleman (RSA) method (which is discussed in Applied Cryptography). In the preferred embodiment, the up-time key pairs are generated by a process on a separate computer and transferred securely on tamper-proof media to the MCS. Alternatively, a process running on the Master Control Module 200 or the INS Control Module could be configured to generate the key pairs. In addition, it may be possible to bypass or omit the Unissued Up-time Key Repository 260 and generate key pairs on an as needed basis. Each key and further information can be embedded within a certificate and digitally signed such as, for example, using an x.509 certificate format, and automatically extracted from the certificate as necessary.

Algorithmic Processing Module 212 is configurable to manipulate data collected from the internal data stores as well as from external data sources via the Master Control Module 200. The manipulated data may be used to update the Master INS Data Store 270 and the Master Accounts Data Store. Such data is used for indexing internal data to external data and decision processing.

In another embodiment, the system is configurable to securely route the Hyper Text Transfer Protocol (“HTTP”). As in the case of email, the user submits an HTTP request in the conventional fashion and the process of securing communications is invisible to the user. The system automatically determines if the destination of the HTTP request enables configuration of secure communications and if so it automatically configures the system and communicates the HTTP request securely. The system is also configurable to process other protocols and is not limited to those mentioned herein. In addition, as in the email example discussed above, any pair of INSs can be automatically configured to communicate via an alternate communications network without the need for clients or servers located on the LANs associated with each INS to reconfigure addresses. Each INS maps and un-maps the respective IP addresses enabling communications to occur without the need for manual address reconfiguration or behavioral modification by a user client accessing an HTTP server.

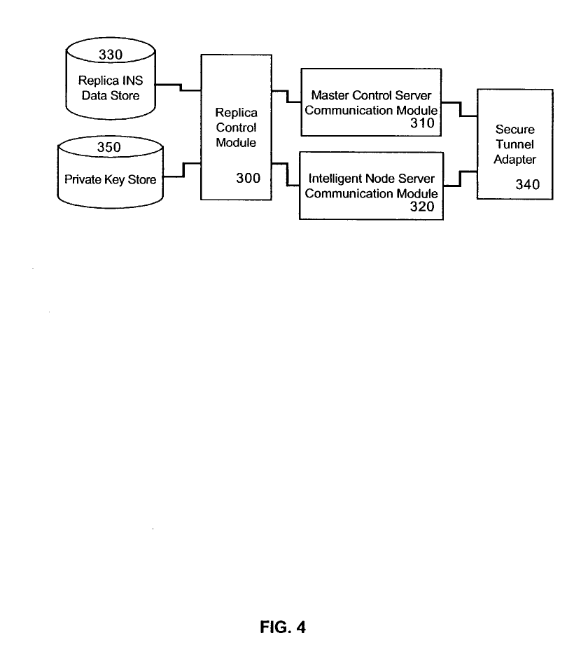

The configuration information maintained by the MCS may be periodically transferred to Replica Control Servers (RCS) 10 (FIGS. 1 and 4), which are duplicates of the MCS. The RCSs provide redundancy, which increases system reliability and availability. In addition, the RCSs allow for load balancing so that the various tasks performed by the MCS can be divided among several independent servers, which improves system performance. To transfer the configuration information to the RCS, the Replica Control Server Communication Module 230 configures the Secure Tunnel Adapter 240 to enable communications with each RCS in a manner similar to communication between two INSs.

In addition to maintaining the Master INS Data Store 270, the MCS also handles the enrollment of INSs. The Automatic Enrollment Module 210 is configured to automatically enroll each pre-qualified INS without manual intervention. The Master Control Module 200 updates the enrollment status of each INS in the Master INS Data Store 270 as it enrolls or unenrolls an INS. The enrollment status of an INS is communicated to other INSs during the INS updating process so that the Local INS Data Store 170 of each of the other INSs is automatically updated to reflect enrollments and unenrollments without manual steps.

Account information, such as pre-qualification status, for each INS is stored in the Master Accounts Data Store 250. This information includes contact information for the administrator of the LAN, pre-qualification data, the IP address of the LAN's mail server and activity logs. The contact information and pre-qualification data are provided by each organization via the Secure Data Exchange Module 290 in the pre-qualification process as further discussed below. In the preferred embodiment, the Secure Data Exchange Module 290 comprises a web browser operated by the local domain administrator using a Secure Sockets Layer (SSL) connection to the MCS.

The Master Control Module 200 applies data from the master Accounts Data Store 250 and invokes the Software Manufacturing Module 285. The Software manufacturing Module 285 produces uniquely configured INS software for each pre-qualified INS. In the preferred embodiment, the software includes the operating system for the INS computer. In an alternative embodiment, the software for running the INS and the operating system of the INS are provided separately. The INS software may be delivered to the INS through an Internet download or provided on a computer-readable medium. In yet another embodiment, some or all of the INS software is manufactured to be installed on the firmware of computing devices. Such computing devices may contain application-specific hardware that substitutes hardware for software components of the system.

FIG. 4 is a block diagram showing the components of the Replica Control Server (RCS). The RCS may be implemented on a computer that is connected to participating LANs via one or more networks, such as the Internet or a private network. Alternatively, the RCS may be implemented on a server that is part of a participating LAN. The RCS is controlled by the Replica Control Module 300 which initiates and manages communication processes and communications among the modules of the RCS.

The RCS maintains a Replica INS Data Store 330, which is a copy of the database of configuration information for all of the participating LANs stored in the Master INS Data Store 270 (FIG. 3) of the MCS. The RCS communicates with the Master Control Server to synchronize the Replica INS Data Store 330 with the Master INS Data Store 270. To communicate with the MCS, the Replica Control Module 300 invokes the Master Control Server Communications Module 310 to configure the Secure Tunnel Adapter (STA) 340 to form a secure tunnel with the STA of the MCS. The RCS acts as a duplicate for the MCS serving as a source for configuration information for the INSs. The RCS has an Intelligent Node Server Communication Module 320 that configures the Secure Tunnel Adapter 340 to communicate with each INS in a manner similar to communication between two INSs. The RCS has private keys that are stored in the Private Key Store 350. The RCS uses these keys in the authentication process between the RCS and the INSs.

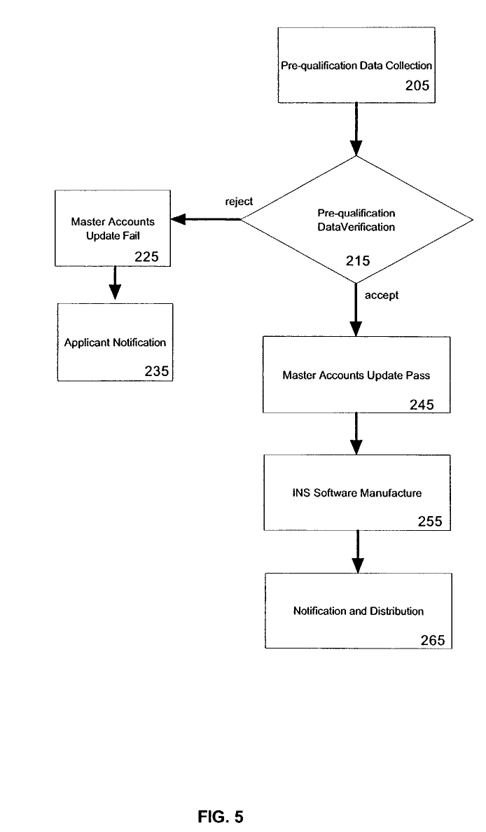

FIG. 5 is a flow diagram of the pre-qualification process used by a Local Domain Administrator (LDA) seeking to participate in the system. First, the LDA submits certain information in the Pre-qualification Data Collection Step 205 to the MCS. In the preferred embodiment, the pre-qualification data is submitted using an Internet browser connected to the Secure Data Exchange Module 290 (FIG. 3) of the MCS via a secure communications session, such as a Secure Sockets Layer (SSL) session. The pre-qualification data includes domain or LAN ownership information, contact information, mail server IP address, and the IP address reserved for the INS. The data also may include financial information, such as credit card or bank account information, to further identify the LDA and to provide a means for billing the LDA for participation in the system. The collected data is stored in the Master Accounts Data Store 250.

The collected data is compared by the Automatic Enrollment Module 210 (FIG. 3) of the MCS to benchmark data for verification in the Pre-qualification Data Verification Step 215. If the pre-qualification data does not meet the benchmark requirements, the Master Accounts Data Store 250 is updated to reflect the failure status of the verification in the Master Accounts Update Fail Step 225. For example, the IP address of the LDA may be checked against domain name and IP address registries and databases, such as the U.S. Department of Commerce's InterNIC database, Reseaux IP Europeens (RIPE), the Internet Assigned Numbers Authority (IANA), International Telecommunications Union (ITU) compliant databases and the American Registry for Internet Numbers (ARIN). The LDA is notified of the verification failure in the Applicant Notification Step 235. Alternatively, the pre-qualification data may be collected through the manual steps of receiving the information by mail, phone, email, etc., and entering the information into the MCS.

If the pre-qualification data meets the benchmark requirements, the Master Accounts Data Store 250 (FIG. 3) is updated to reflect the successful verification status in the Master Accounts Update Pass Step 245. The Software Manufacturing Module 285 of the MCS then generates the INS operating software in the INS Software Manufacture Step 255, i.e., prepares a copy of the software for use by the particular INS.

During the generation of the INS operating software, it is embedded with identification information that uniquely identifies the LAN. The unique identifier, e.g., a Global Unique Identifier (GUID), may be derived from or contain a subset of the collected pre-qualification data, such as a hash of the pre-qualification data or be a private key. The unique identifier also may be derived from a random process. For example, the MCS may generate a GUID for one or more INSs for that LAN. As a further example of a unique identifier, the MCS may generate a certificate containing a private/public encryption key pair for that INS while the MCS keeps a copy of the public key. As an alternative to generating the INS operating software, the Software Manufacture Module 285 may produce only the unique identifier, which is transmitted to a hardware device on which the INS operating software has been installed. The unique identifier may also be burned directly into firmware.

The LDA is notified of the successful pre-qualification and the INS operating software is distributed. In the preferred embodiment, the INS operating software is downloaded from the Secure Data Exchange Module 290 (FIG. 3) of the MCS via a secure communications session, such as a Secure Sockets Layer (SSL). The LDA then records the INS operating software to media that is preferably read-only and used to boot and host the INS. Alternatively, the INS operating software may be distributed to the LDA on a computer-readable medium or downloaded to the computing device hosting the INS directly from the Secure Data Exchange Module 290.

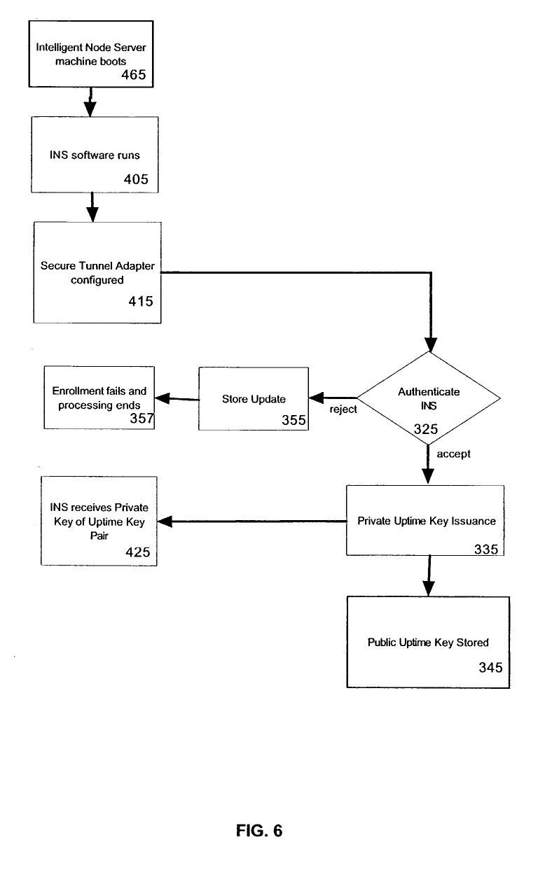

FIG. 6 shows a flow diagram for the Automatic Enrollment Process, which is performed at least once, for example, every time the INS is turned on or boots (Step 465). Once a LAN has been pre-qualified, the INS installed in the LAN is configured to automatically enroll with the MCS to participate in the system.

The INS operating software is configured to begin execution (Step 405) after the INS boots. In the preferred embodiment, the INS operating software is stored on a read-only computer-readable medium, such as a compact disk. Alternatively, the INS operating software is loaded to the firmware or a storage medium of the computing device. In yet another embodiment, the INS operating software is loaded dynamically via a data network by a “stub”, for example, an INS loader program running on a computing device in the network.

Once the INS operating software begins execution, the INS Control Module 100 (FIG. 2) initiates communication (Step 415) with the Automatic Enrollment Module 210 (FIG. 3) of the MCS via a Secure Tunnel Adapter 140. The INS signals the MCS to request enrollment (Step 325) and submits enrollment information such as, for example, identification information embedded in the uniquely configured INS operating software or connected device and collected environmental information. The Automatic Enrollment Module 210 of the MCS compares the submitted enrollment information to information stored in the Master Accounts Data Store 250 to authenticate the INS seeking enrollment (Step 355). 100821 If the Automatic Enrollment Module 210 (FIG. 3) cannot authenticate the INS, the INS enrollment is rejected, the Master Accounts Data Store 250 is updated (Step 355) to reflect the authentication failure and processing ends 357. If the INS is authenticated and the enrollment is accepted, the Automatic Enrollment Module 210 retrieves an unused up-time key pair (i.e., a private up-time key and a public up-time key) from the Unissued Up-time Key Repository 260 of the MCS. The Private Up-time Key is communicated to the INS (Step 355) and stored in the Private Up-time Key Store 160 of the INS (Step 425). In the preferred embodiment, the private up-time key is permanently purged from the MCS after it is communicated to the INS. The public up-time key is then stored in the Master INS Data Store 270 of the MCS (Step 345).

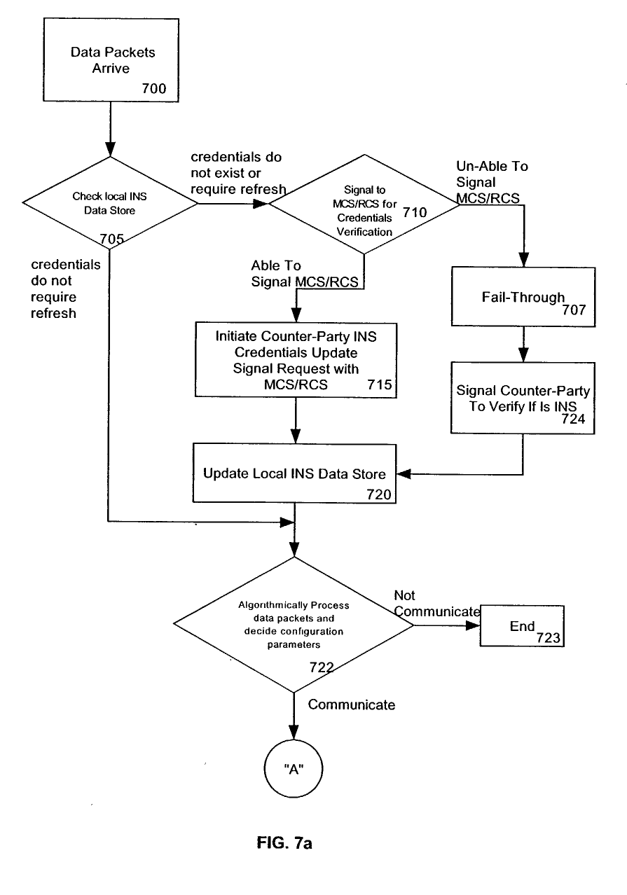

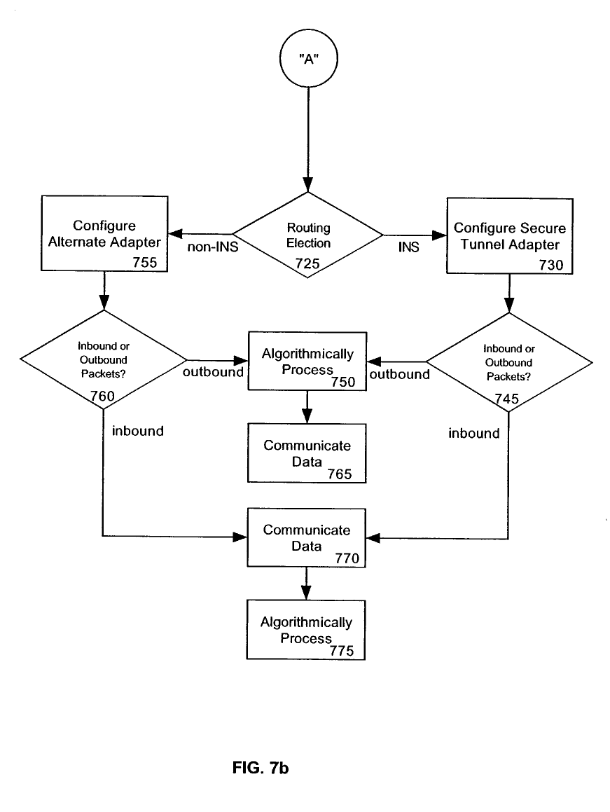

FIGS. 7a and 7b are a flow diagram of an example of the steps taken for communication between INSs. The process begins when an INS receives an inbound packet or sends an outbound packet (Step 700). The INS Control Module 100 (FIG. 2) checks the Local INS Data Store 170 (Step 705) to obtain credentials and configuration information for the INS sending the data packet (for inbound data) or the intended recipient INS (for outbound data).

In the preferred embodiment, if the Local INS Data Store 170 (FIG. 2) has an entry for the counter-party INS (Step 705), the INS signals the MCS for a credentials status check (Step 710). In an alternative embodiment, the INS may use the credentials in the Local INS Data Store 170 without signaling the MCS for a counter-party credentials status check (step 710), thus relying on periodic credentials status checks rather than the real-time method employed in the preferred embodiment.

In either embodiment, if there is no entry in the local INS Data Store 170, or the MCS Master Control Module 200 (FIG. 3) determines that the credentials and/or configuration information have been modified, then when a counter-party INS credential update request is signaled (Step 715) to the MCS or an RCS, the current counter-party credentials are signaled to the INS and the INS Control Module 100 (FIG. 2) updates the Local INS Data Store 170 accordingly (Step 720). An INS is configurable to signal the MCS for a credentials update request (Step 715) every time a counter-party INS communication session is needed. These alternative credential status check and update sequences may be used together and optimized according to data communication and processing overhead requirements. The Algorithmic Processing Module 110 may be configured to perform such optimizations and select an alternative configuration for each initiation of INS-to-INS communication.

If the INS is unable to communicate with the MCS to complete a credentials update, the INS will attempt to establish communication in the fail-through mode (Step 707). The fail-through mode communication may be established in a number of ways, as determined by rules maintained by the Algorithmic Processing Module (APM) 110. For example, if there is an expired entry for the counter-party INS in the Local INS Data Store 170, the APM may allow the INS to establish communication using the expired information. As a further example, as discussed above, the INSs periodically receive certificates from the MCS, which acts as a Certificate Authority. An INS may authenticate a counter-party INS by verifying the digital signature of a certificate received from the counter-party INS along with other information, such as the IP address of the counter-party INS.

Once the credentials of the counter-party INS have been verified and/or updated, the APM 110 (FIG. 2) determines (Step 725) whether and how the Secure Tunnel Adapter 140 is to be configured for communication with a recipient INS (Step 730) or an Alternate Adapter 150 is to be configured (Step 755) for communicating with an unenrolled or non-participating LAN. If the Secure Tunnel Adapter 140 is selected, then it is configured by the Intelligent Node Server Control Module 120 (Step 730).

Once the Secure Tunnel Adapter 140 or the Alternate Adapter 150 is selected, further algorithmic processing by the APM 110 and data communication may be performed in a particular order depending upon whether the data packets are inbound or outbound. In the case of outbound data packets, the further algorithmic processing (Step 750) is performed prior to data communication (Step 765). In the case of inbound data packets, the further algorithmic processing (Step 775) is performed subsequent to data communication (Step 770).

The algorithmic processing (Steps 750 and 775) may be performed at any layer of the Open Standards Interconnection (OSI) model of the International Standards Organization. Each layer of the OSI model, from the application layer (the top layer) to the physical layer (the bottom layer) handles a different aspect of data communications. For example, in the preferred embodiment, SMTP messages are processed to provide authentication verification messages to the user. Such messages are appended by a process running at the Application Layer. When the system is processing protocols other than SMTP, the algorithmic processing (Steps 750 and 775) may be performed at a different level of the OSI model. In general, the other features of the system described herein can be implemented on at least one OSI layer and, in many cases, more than one For example, encryption could be performed at the network layer using an IPSEC encryption scheme or at a higher layer, such as the application layer, using other encryption algorithms. One example of algorithmic processing is the supplementation of an email. In cases where it is desirable to append a document or text to an email, a process running at the application level of the OSI model is triggered by the Algorithmic Processor (Steps 750 and 775). Another case is where a mathematical calculation is performed on the email. One such calculation is known to those skilled in the art of cryptography as hashing. The resulting hash of the email, or alternatively a component of the email, would be stored. Such hashes can also be used in producing digital signatures within the system, automatically, using algorithmic rules. The algorithmic processing module is configurable to transmit these digital signatures as well as other data to data stores as well a retrieve digital signatures and other data from data stores. Using retrieved digital signatures Steps 750 and 775 are used to compare previously digitally signed emails or components of emails with previously stored signatures thus verifying authenticity of emails and the integrity of components of emails as well as any other type of messages, such as Extensible Markup Language (XML) messages.

Algorithmic Processing Module 10 (FIG. 2) is configurable to manipulate data collected from the Master Control Server, Local INS Data Store 170 and from external data sources. The manipulated data may be used to update the Local INS Data Store 170 and for decision processing. For example, the INS may be configured to compare data held in Local INS Data Store 170 with data obtained from an external source, such as address information in an external DNS system, and make a processing decision based upon the result. As a further example, the Algorithmic Processing Module 10 may be configured to obtain a file from an external data store for further processing, such as when the INS seeks to verify the digital signature of a certificate using information from a Certificate Authority (CA).

The Algorithmic Processing Module 212 (FIG. 3) of the MCS and Algorithmic Processing Module 110 (FIG. 2) of the INS are both configurable to trigger other events in addition to triggering configuration and routing decisions and request of credentials from the MCS or an RCS or triggering the build-up and tear-down of tunnels. For example, the Algorithmic Processing Module is configurable to trigger acquisition of data to update a local or remote data store as well as transmission of data to local or remote data stores.

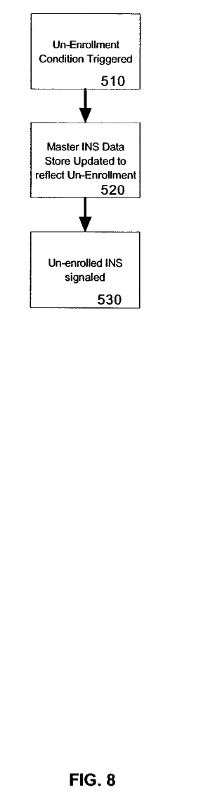

FIG. 8 is a flow diagram of the automatic unenroliment process that prevents an INS from performing further communication with other INSs. The process is initiated when an unenrollment condition is triggered (Step 510) such as, for example, when the INS operating software is shut down or when it is no longer desirable to allow an INS to participate in the system (for non-payment, abuse of system, etc.). The Master INS Data Store 270 is updated to reflect the status of the unenrolled INS (Step 520). In the preferred embodiment, the status of the unenrolled INS is signaled to all participating INSs (Step 530) so that each Local INS Data Store 170 is updated. Alternatively, the status of the unenrolled INS may be signaled to each INS the next time it attempts to communicate with the unenrolled INS.

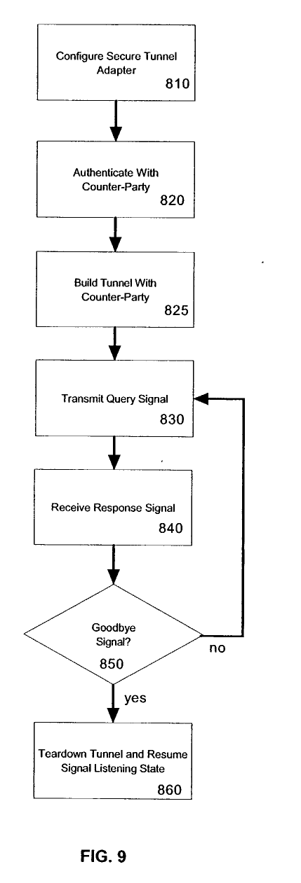

FIG. 9 is a schematic of the secure signaling system. When the MCS, RCS, or an INS requires data from another of the components, it utilizes the signaling system to satisfy its data requirements. The signaling system always operates securely, as all components are configured to authenticate with other components by building tunnels (Step 810) via each STA and configured to encrypt communications. The signaling system enables each component to configure its respective tunnel adapter to communicate securely with another component of the system or an external component. Once the signaling system has authenticated with the counter-party component (Step 820), a tunnel is established with that component (Step 825). Next, the initiating component signals the recipient component (Step 830) requesting a payload of data. The recipient component employs its Algorithmic Processing Module to respond to the request and may initiate data requests via the signaling system or conventionally to obtain data for algorithmic processing so that it may respond (Step 840) to the requesting signal. The process is iterative, as the algorithmic processors of the initiating and recipient components process data transmissions until a satisfactory condition is achieved. At such time, a goodbye signal is generated (Step 850) and the secure signaling session is terminated (Step 860).

It will be appreciated that each of these embodiments discussed above provides a novel method and system for automatically configuring and operating secure network communications in dynamic data communications topologies.

It will also be appreciated that because each participating LAN has an Intelligent Node Server that automatically enrolls in the system, a disparate and ever-changing array of LANs can communicate securely without prior coordination and cumbersome, time-consuming manual configuration.

Further, it will also be appreciated that security is not limited solely to the simple authentication and encryption of data. The current DNS fails to provide an independent reference that is automatically checked to ensure that the DNS registry has not been tampered with or corrupted. The present invention enables automatic multi-registry verification to reduce the risk of such a single point of failure.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

What is claimed:

1. A method for pre-qualifying a node to participate in a system for automatically establishing secure communications through one or more networks, the method comprising the steps of:
receiving pre-qualification data from a node via a network;
comparing the pre-qualification data a benchmark;
creating an entry for the node in an account database if the pre-qualification data meet the benchmark;
generating a unique identifier for the node;
storing the unique identifier in a master node server database;
associating the unique identifier with a copy of node server operating software; and
delivering the copy of node server operating software to the node.

2. The method of claim 1, wherein the unique identifier is derived from the pre-qualification data.

3. The method of claim 1, wherein the unique identifier comprises a signed certificate containing an unique identification key.

4. The method of claim 1, wherein the unique identifier comprises an Internet Protocol address of the node.

5. A system for pre-qualifying a node to participate in a system for automatically establishing secure communications through one or more networks, the system comprising:
a secure data exchange module configured to receive pre-qualification data from a node via a network;
a control module configured to compare the pre-qualification data to a benchmark, create an entry for the node in an account database if the pre-qualification data meets the benchmark, generate a unique identifier for the node, and store the unique identifier in a master node server database; and
a software manufacture module configured to associate the unique identifier with a copy of node server operating software deliver the copy of node server operating software to the node.

6. The system of claim 5, wherein the unique identifier is derived from the pre-qualification data.

7. The system of claim 5, further comprising a certification authority, wherein the unique identifier comprises a certificate generated and signed by the certification authority and containing at least one unique identification key.

8. A method for automatically enrolling in a system for establishing secure communications through one or more networks, the method comprising the steps of:
initiating execution of node server operating software on first node server;
authenticating a secure communication connection via a network between a first node server and a master control server having an account database;
verifying an account status of the first node server by accessing the account database;
associating, in the master control server, a unique identification key pair with the first node server, the identification key pair having a public key and a private key;
storing the public key of the key pair in a master node server database on the master control server; and
storing the private key of the key pair in the first node server.

9. The method of claim 8, further comprising the step of purging the private key from the master control server.

10. A method for automatically enrolling in a system for establishing secure communications through one or more networks, the method comprising the steps of:
initiating execution of node server operating software on first node server;
authenticating a secure communication connection via a network between a first node server and a master control server having an account database;
verifying an account status of the first node server by accessing the account database;
associating, in the master control server, a unique identification key pair with the first node server, the identification key pair having a public key and a private key;
storing the public key of the key pair in a master node server database on the master control server;
storing the private key of the key pair in the first node server;
communicating to a second node server at least a portion of the master node server database, including the public key associated with the first node server; and
communicating to the first node server at least a portion of the master node server database, including a public key associated with the second node server.

11. The method of claim 10, further comprising the steps of:
authenticating secure communication between the second node server and the first node server using the public key associated with the first node server; and
authenticating secure communication between the first node server and the second node server using the public key associated with the second node server.

12. A system for automatically enrolling to establish secure communications through one or more networks, the system comprising:
a first node server configured to initiate execution of node server operating software;
a master control server having an account database;
a secure tunnel adapter configured to authenticate a secure communication connection between the first node server and the master control server via a network;
an automatic enrollment module in the master control server that verifies an account status of the first node server by accessing the account database;
a key-issuing module in the master control server having a unique identification key pair associated with the first node server;
a master node server database in the master control server for storing a public key of the key pair; and
a private key database in the first node server for storing a private key of the key pair.

13. A method for automatically establishing secure communications through one or more networks, the method comprising the steps of:
receiving data at a first node server via a network;
if the data includes credentials of a second node server, determining whether a local node server database of the first node server has an entry for the second node server;
if there is an entry for the second node server in the local node server database of the first node server, checking the credentials of the second node server using the local node server database of the first node server;
if there is not an entry for the second node server in the local node server database of the first node server or the credentials of the second node server do not pass the checking step, requesting an update of the local node server database from a master node server database on a master control server and repeating the checking step; and
determining whether to route the data through a secure tunnel adapter based on a result of the checking step.

14. The method of claim 13, further comprising the step of, if the master control server is inaccessible, allowing the first node server to authenticate the second node server using credentials of the second node server that have not passed the checking step.

15. The method of claim 13, further comprising the step of, if the master control server is inaccessible, allowing the first node server to authenticate the second node server using a digitally signed certificate previously received from the master control server.

16. The method of claim 13, further comprising the step of modifying address information associated with the data to route the data through a selected one of the one or more networks.

17. A system for automatically establishing secure communications through one or more networks, the system comprising:
a master control server having a master node server database storing credentials for participating nodes;
a first node server configured to receive data via a network, the first node server having a local node server database;
an algorithmic processing module for determining, when the data received by the first node server includes credentials of a second node server, whether the local node server database of the first node server has an entry for the second node server and for routing the data through a secure tunnel adapter based on the determination,
wherein if there is an entry for the second node server in the local node server database of the first node server, the algorithmic processing module checks the credentials of the second node server using the local node server database of the first node server, and
if there is not an entry for the second node server in the local node server database of the first node server or the credentials of the second node server do not pass the checking step, the algorithmic processing module requests an update of the local node server database from the master node server database on a master control server and repeats the checking step.

18. The system of claim 17, wherein, if the master control server is inaccessible, the algorithmic processing module allows the first node server to authenticate the second node server using credentials of the second node server that have not passed the checking step.

19. The system of claim 17, wherein, if the master control server is inaccessible, the algorithmic processing module allows the first node server to authenticate the second node server using a digitally signed certificate previously received from the master control server.

20. The system of claim 17, wherein the algorithmic processing module modifies address information associated with the data to route the data through a selected one of the one or more networks.

21. Computer code for pre-qualifying a node to participate in a system for automatically establishing secure communications through one or more networks, the computer code comprising code for:
receiving pre-qualification data from a node via a network;
comparing the pre-qualification data a benchmark;
creating an entry for the node in an account database if the pre-qualification data meet the benchmark;
generating a unique identifier for the node;
storing the unique identifier in a master node server database;
associating the unique identifier with a copy of node server operating software; and
delivering the copy of node server operating software to the node.

22. The computer code of claim 21, wherein the unique identifier is derived from the pre-qualification data.

23. The computer code of claim 21, wherein the unique identifier comprises a signed certificate containing an unique identification key.

24. Computer code for automatically enrolling in a system for establishing secure communications through one or more networks, the computer code comprising code for:
initiating execution of node server operating software on first node server;
authenticating a secure communication connection via a network between a first node server and a master control server having an account database;
verifying an account status of the first node server by accessing the account database;
associating, in the master control server, a unique identification key pair with the first node server, the identification key pair having a public key and a private key;
storing the public key of the key pair in a master node server database on the master control server; and
storing the private key of the key pair in the first node server.

25. The computer code of claim 24, further comprising code for purging the private key from the master control server.

26. Computer code for automatically establishing secure communications through one or more networks, the computer code comprising code for:
initiating execution of node server operating software on first node server;
authenticating a secure communication connection via a network between a first node server and a master control server having an account database;
verifying an account status of the first node server by accessing the account database;
associating, in the master control server, a unique identification key pair with the first node server, the identification key pair having a public key and a private key;
storing the public key of the key pair in a master node server database on the master control server;
storing the private key of the key pair in the first node server;
sending to a second node server at least a portion of the master node server database, including the public key associated with the first node server; and
sending to the first node server at least a portion of the master node server database, including a public key associated with the second node server.

27. The computer code of claim 26, further comprising code for:
authenticating secure communication between the second node server and the first node server using the public key associated with the first node server; and
authenticating secure communication between the first node server and the second node server using the public key associated with the second node server.

28. Computer code for automatically establishing secure communications through one or more networks, the computer code comprising code for:
receiving data at a first node server via a network;
if the data includes credentials of a second node server, determining whether a local node server database of the first node server has an entry for the second node server;
if there is an entry for the second node server in the local node server database of the first node server, checking the credentials of the second node server using the local node server database of the first node server;
if there is not an entry for the second node server in the local node server database of the first node server or the credentials of the second node server do not pass the checking step, requesting an update of the local node server database from a master node server database on a master control server; and
determining whether to route the data through a secure tunnel adapter based on a result of the checking step.

29. The computer code of claim 28, further comprising code for, if the master control server is inaccessible, allowing the first node server to authenticate the second node server using credentials of the second node server that have not passed the checking step.

30. The computer code of claim 28, further comprising code for, if the master control server is inaccessible, allowing the first node server to authenticate the second node server using a digitally signed certificate previously received from the master control server.

31. The computer code of claim 28, further comprising code for modifying address information associated with the data to route the data through a selected one of the one or more networks.
